(19) United States
(12) Patent Application Publication
(10) Pub. No.: US 2005/0278601 A1
(43) Pub. Date: Dec. 15, 2005

(54) Increasing reliability of receiving control messages

(75) Inventors: William K. Morgan, Marengo, IL (US); William R. Bayer, Wilmette, IL (US); Donald P. Cordell, Woodstock, IL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/865,523

(22) Filed: Jun. 10, 2004

(51) Int. Cl. H04L 5/14; H04J 3/16; H04J 3/22; H04L 1/18; G08C 25/02

(52) U.S. Cl. 714/748

(57) ABSTRACT

A controller (100) for a wireless communication system determines whether a multiframe control message is imminent, and activates (404, 406) a buffer (112) for storing received frames of a first transmission (202, 204, 206) of the multiframe control message, when the multiframe control message is imminent. The controller receives a retransmission (302, 304, 306) of the multiframe control message, when a received frame of the multiframe control message has an erasure, and reconstructs (500) the multiframe control message from corresponding received frames of both the first transmission and the retransmission.

### FIELD OF THE INVENTION

This invention relates in general to wireless communication systems, and more specifically to a method and apparatus for increasing a reliability of receiving control messages, such as multiframe control messages.

### BACKGROUND OF THE INVENTION

In 2G (generation) and 3G CDMA wireless communication systems, once a mobile unit is assigned to a traffic channel, the control signaling associated with the call is sent over that traffic channel. A majority of control signals can fit into a single over-the-air (OTA) traffic frame. A few critical control messages, e.g., call setup messages, require multiple OTA traffic frames due principally to size.

In prior-art systems, whenever any of the frames of a message fails transmission, the entire message is discarded and must be resent thus using precious airtime. This can be particularly troublesome when the message is a multiframe sequence. Unfortunately, the requirement for perfectly receiving all frames of each multiframe message sequence before the message is usable results in degraded transmission reliability, especially for the multiframe messages, since multiple retransmissions of the multiframe sequence can be required.

Thus, what is needed is a method and apparatus for improving/increasing the reliability of receiving control messages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electrical block diagram of an exemplary controller.

FIG. 2 is a diagram depicting an exemplary transmission of a multiframe message.

FIG. 3 is a diagram depicting an exemplary retransmission of the multiframe message.

FIG. 4 is a flow diagram depicting a first operation of the controller.

FIG. 5 is a flow diagram depicting a second operation of the controller.

### DETAILED DESCRIPTION OF THE PREFERRED EMBODIMENTS

In overview, the present disclosure concerns communications systems that utilize receivers to provide service for communications units or more specifically a user thereof operating therein. More particularly, various inventive concepts and principles embodied as a method and apparatus for improving or increasing reliability of receiving single or multiframe control messages for use in equipment with such communications systems will be discussed and disclosed. The communications systems of particular interest are those being deployed and developed such as CDMA (Code Division Multiple Access), W-CDMA (Wideband-CDMA), CDMA2000, 2G (Generation), 2.5G, 3G, UMTS (Universal Mobile Telecommunications Services), GPRS (GSM packet radio service) systems and evolutions thereof that utilize spread spectrum signals, although the concepts and principles have application in other systems and devices.

Examples of control messages or signaling where the principles and concepts of the present invention may be advantageously utilized include, for example, origination, page response, RLP/RLC (radio Link protocol/radio Link control) retransmissions & ACK/NAKs, data burst messages (including short data burst and short message service). The principles and concepts can be utilized on a variety of channel types, including, for example, dedicated (such as the fundamental channel in CDMA systems) channels, common channels (such as the paging and access channels), and other channel types.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in one or more conventional digital signal processors (DSPs), or with integrated circuits (ICs) such as custom or Application Specific ICs (ASICs) and corresponding software instructions. It is expected that one of ordinary skill, notwithstanding possibly significant effort and many design choices motivated by, for example, available time, current technology, and economic considerations, when guided by the concepts and principles disclosed herein will be readily capable of programming such DSPs, or generating such ICs with minimal experimentation. Therefore, in the interest of brevity and minimization of any risk of obscuring the principles and concepts according to the present invention, further discussion of such DSPs and ICs, if any, will be limited to the essentials with respect to the principles and concepts employed by the preferred embodiments.

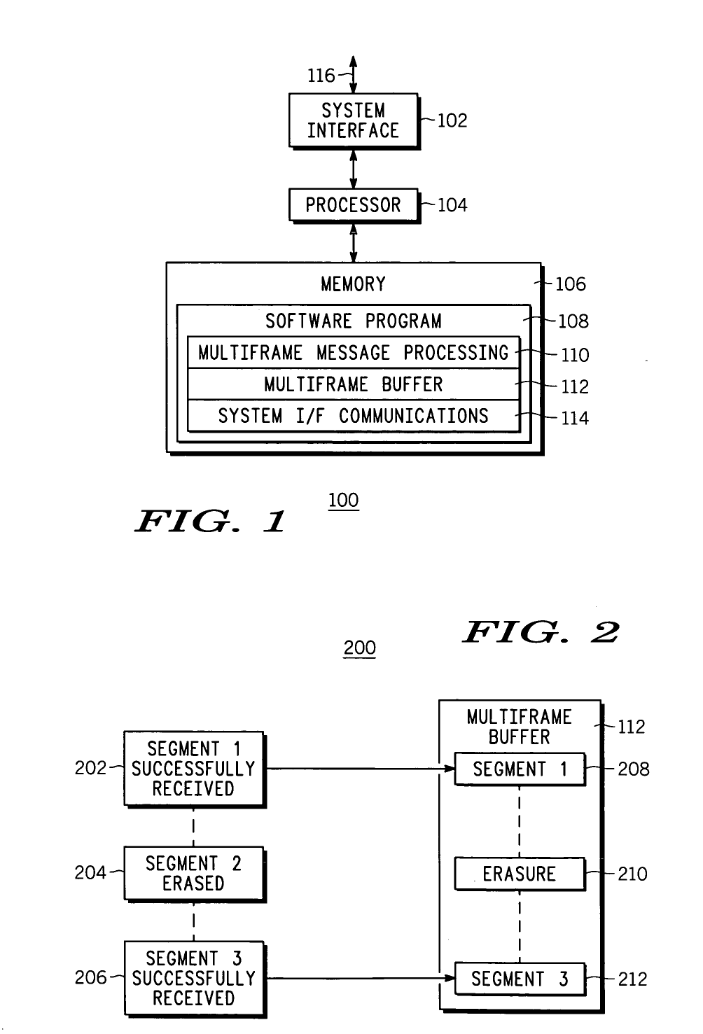

Referring to FIG. 1, an electrical block diagram depicts an exemplary controller 100 in accordance with the present invention, comprising a processor 104 for directing operations of the controller 100. The controller 100 further comprises a memory 106 coupled to the processor 104 and comprising a software program 108 including executable instructions and data for programming the processor 104. The software program 108 comprises a multiframe message processing program 110 for programming the processor 104 to process multiframe messages in accordance with the present invention, as disclosed further herein below. The software program 108 further comprises a multiframe buffer 112 for storing received frames of a first transmission of the multiframe message. In addition, the software program 108 includes a system interface communications program 114 for programming the processor 104 to control a system interface 102 to communicate with the wireless communication system over a conventional communications link 116 for cooperating with the wireless communication system to process the multiframe messages in accordance with various exemplary embodiments.

We now will disclose and discuss in greater detail the reasons for the decreased reliability of messages, such as multiframe messages and our solutions therefor. In CDMA, once a mobile is assigned to a traffic channel, the control signaling associated with the call is sent over this traffic channel. Many signaling messages in CDMA can fit within one 20 ms Over The Air (OTA) traffic frame. However, there are critical messages that have to be sent over multiple OTA frames due to size. Such messages are often sent during call setup. In one embodiment, the composite frame error rate (FER) for the traffic channel is targeted at 1%. Probability theory shows that the reception of a correct multiframe message is worse than that of a signaling message that can fit within a single over the air transmission.

The probability that an entire multiframe sequence is received successfully during a single attempt is approximately, assuming independent erasures, (1-FER)\hat{ }N where N is the number of successive OTA frames required for the message. For a 1% FER environment the probability that a 3-frame message is successfully received during one attempt is 0.99\hat{ }3=0.97 which results in an effective message erasure rate of 3%. The probability gets worse the longer the signaling message is. Additionally, there may be times during a call where the RF may temporarily degrade and have a short term FER of 5%, 10% or more. This further decreases the probability of a successful transmission. The prior-art systems try to combat this by simple retransmissions. It should be noted that increasing the reliability of any single frame will improve or increase the reliability of the multiframe sequence or message as well and thus avoid wasting airtime or channel capacity for retransmissions.

A specific problem in, for example, various known CDMA systems is the reception of a status response message. Other systems often have similar messages that can be multiframe or otherwise critical to operation. Failure to receive this message at the infrastructure results in the infrastructure being unable to set up the call, due to receiving insufficient mobile status information. The problem has become worse for 3G mobiles vs. 2G mobiles. The status response message contains a listing of all the service configurations the mobile supports. For a 2G mobile, this results in a message that traverses 3 frames. The newer 3G mobiles are generating a message that traverses 8 frames. When even one of the multiple frames fails reception, the entire message is discarded and the entire multiframe sequence has to be resent—often several times. Each retransmission undesirably extends the call setup time and also increases the likelihood of a failed call setup.

In one embodiment in accordance with the present invention the central base station controller (CBSC) monitors when a multiframe signaling message is imminent. The CBSC is represented by the controller 100, which has been simplified to avoid obscuring the present invention. It will be appreciated that in a practical system the CBSC will have additional elements. When the multiframe signaling message is expected within a predetermined time after being requested by the controller 100, the controller 100 activates the multiframe buffer 112. If the received signaling message fails its CRC16 check, the controller 100 will buffer up the pieces of the multiframe message based on the success of the over the air CRC result. Upon a failure of reception of one or more of the message segments (preferably indicated by an erasure of each unsuccessfully received message segment), the controller 100 preferably will request a retransmission. The controller 100 is aware that the retransmission is imminent and will perform a mix and match operation with previously successfully received pieces or frames of the anticipated signaling message until a combination results in a complete copy of the signaling message. Additional retransmissions are required when the original transmission and the first retransmission do not contain enough successfully received pieces to reconstruct the signaling message. During call set up in particular, the mobile operates in a speak only when spoken to mode. The multiple frame signaling message is the direct result of a query from the controller 100. The controller 100 thus is aware that the mobile unit will be responding only with the requested (multiframe) signaling message. It will be appreciated that, alternatively, in response to discovering the erasure, the controller 100 can send to the mobile unit a negative acknowledgement or no response, instead of requesting the retransmission.

FIG. 2 is a diagram 200 depicting an exemplary transmission of the multiframe message. In this example, three received message segments 202, 204, 206 are depicted. The first segment 202 was received successfully. The second segment 204 was received with uncorrectable errors and was thus erased using one of various known error detection techniques. The third segment 206 was received successfully. In response, the controller 100 stores the first segment 202 in a first location 208 of the multiframe buffer 112, leaves an erasure in a second location 210, and stores the third segment 206 in a third location 212.

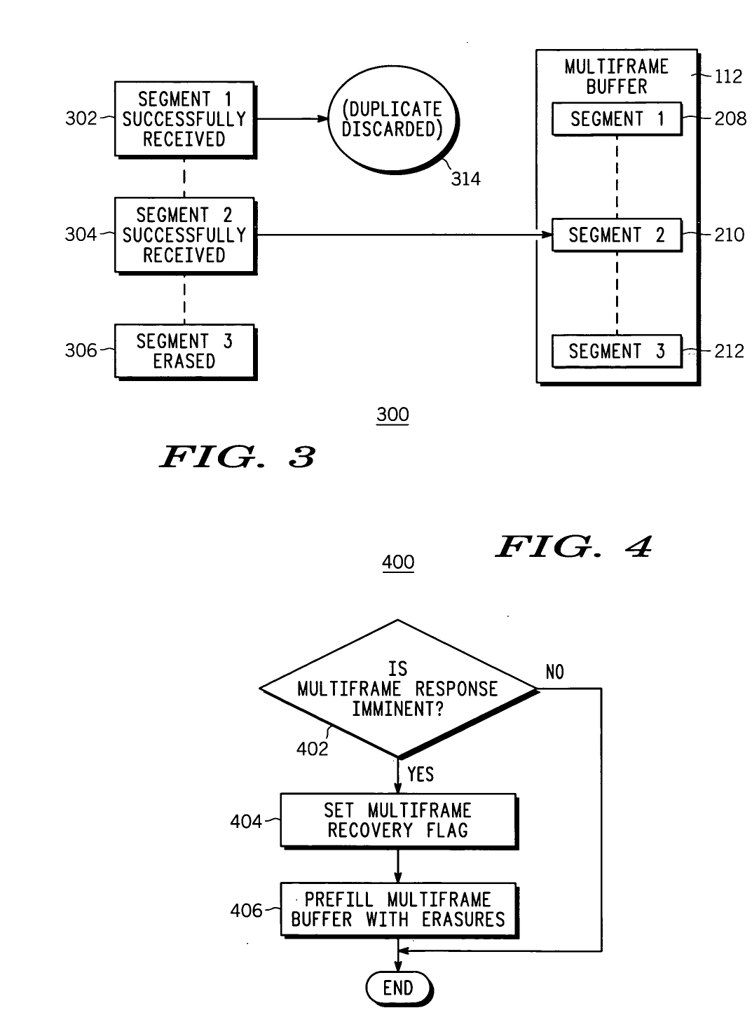

FIG. 3 is a diagram 300 depicting an exemplary retransmission of the same multiframe message depicted in the diagram 200. In this example, the first segment 302 is again successfully received, but is a duplicate of the first segment 202 already in the first location 208 of the buffer 112. Thus, the duplicate first segment 302 is discarded 314. The second segment 304, previously erased, is successfully received this time and is stored in the second location 210 of the buffer 112. The third segment 306 is erased this time, but is not needed anyway, because it was previously received and stored in the third location 212 of the buffer 112, which now advantageously contains all three segments of the multiframe message.

FIG. 4 is a flow diagram 400 depicting a first operation of the controller 100. The flow begins with the controller checking 402 whether a multiframe response is imminent. As disclosed herein above, the controller 100 determines whether the multiframe response is imminent based upon whether the controller 100 has requested a response from the mobile unit, where the response is likely to be a multiframe response. If no multiframe response is expected, the process ends. If, on the other hand, the multiframe response is imminent, the controller 100 sets 404 a multiframe recovery flag and prefills 406 the multiframe buffer 112 with erasures. These measures activate the multiframe buffer 112 for storing each received frame of a first transmission of the multiframe control message.

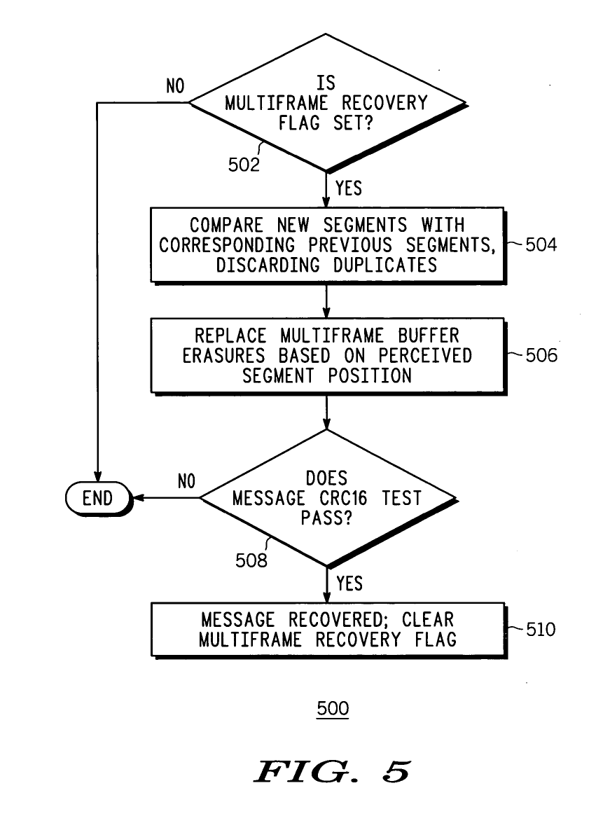

FIG. 5 is a flow diagram 500 depicting a second operation of the controller after the multiframe buffer 112 has been activated. The flow begins with the controller 100 checking 502 whether the multiframe recovery flag is set. If not, the process ends. If, on the other hand, the multiframe recovery flag is set, the controller 100 compares 504 newly received segments with corresponding previously received segments (or erasures) in the buffer 112, discarding duplicate segments. The controller 100 then replaces 506 multiframe buffer erasures based on the perceived position of the segments. The controller 100 then determines 508 whether the CRC16 test passes for the entire message. If not, the process ends, and the retransmission and reception of the multiframe control message, along with the reconstruction of the message is preferably repeated until the message error test is passed. If, on the other hand, the CRC16 test passes, then the multiframe message advantageously has been recovered, and the controller 100 then clears the multiframe recovery flag, effectively deactivating the buffer 112.

Thus, it should be clear from the preceding disclosure that the present invention provides a method and apparatus for substantially improving the reliability of receiving multiframe control messages. The method and apparatus advantageously does not require any changes in the mobile units, however if needed the same principles and concepts can be applied in a mobile device on a downlink or outbound, base to mobile, channel.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method in a controller of a wireless communication system utilizing control messages including multiframe control messages, the method for improving a reliability of receiving the multiframe control messages, the method comprising:
determining whether a multiframe control message is imminent;
activating a buffer for storing received frames of a first transmission of the multiframe control message, when the multiframe control message is imminent;
receiving a retransmission of the multiframe control message, when a received frame of the multiframe control message has an erasure; and
reconstructing the multiframe control message from corresponding received frames of both the first transmission and the retransmission.

2. The method of claim 1, wherein the determining whether the multiframe control message is imminent comprises:
sending a request to a mobile unit in the wireless communication system for the multiframe control message; and
receiving from the mobile unit a response within a predetermined time period.

3. The method of claim 1, wherein the receiving a retransmission of the multiframe control message, when a received frame of the multiframe control message has an erasure comprises:
discovering the erasure; and
in response to discovering the erasure, performing one of:
sending a negative acknowledgment;
sending no response; and
requesting the retransmission.

4. The method of claim 1, wherein the reconstructing the multiframe control message comprises:
discarding a frame of the retransmission that is identical to a corresponding frame of a prior transmission of the multiframe control message; and
replacing an erased frame of the prior transmission with a non-erased frame of the retransmission.

5. The method of claim 1, further comprising
deactivating the buffer after reconstructing the multiframe control message.

6. The method of claim 1 further comprising
repeating the receiving of the retransmission of the multiframe control message and the reconstructing of the multiframe control message until a message error check is passed.

7. A controller for a wireless communication system utilizing control messages including multiframe control messages, the controller for increasing reliability of receiving the multiframe control messages, the controller comprising:
a processor for directing operations of the controller;
a memory coupled to the processor and comprising executable software and data for programming the processor; and
a system interface coupled to the processor for communicating with the wireless communication system,
wherein the executable software programs the processor to:
determine whether a multiframe control message is imminent;
activate a buffer for storing received frames of a first transmission of the multiframe control message, when the multiframe control message is imminent;
receive a retransmission of the multiframe control message, when a received frame of the multiframe control message has an erasure; and
reconstruct the multiframe control message from corresponding received frames of both the first transmission and the retransmission.

8. The controller of claim 7, wherein the executable software further programs the processor to:
send a request to a mobile unit in the wireless communication system for the multiframe control message; and
expect the mobile unit to respond within a predetermined time period.

9. The controller of claim 7, wherein, in receiving a retransmission of the multiframe control message, when a received frame of the multiframe control message has an erasure, the executable software further programs the processor to:
discover the erasure; and
in response to discovering the erasure, perform one of:
sending a negative acknowledgment;
sending no response; and
requesting the retransmission.

10. The controller of claim 7, wherein the executable software further programs the processor to:
discard a frame of the retransmission that is identical to a corresponding frame of a prior transmission of the multiframe control message; and
replace an erased frame of the prior transmission with a non-erased frame of the retransmission.

11. The controller of claim 7, wherein the executable software further programs the processor to
deactivate the buffer after reconstructing the multiframe control message.

12. The controller of claim 7 wherein the executable software further programs the processor to
repeat receiving the retransmission of the multiframe control message and reconstructing the multiframe control message until a message error check is passed.

13. A software program for a controller of a wireless communication system utilizing control messages including multiframe control messages, the software program for improving a reliability of receiving the multiframe control messages, wherein the software program, when installed and operating in the controller, causes the controller to:
determine whether a multiframe control message is imminent;
activate a buffer for storing received frames of a first transmission of the multiframe control message, when the multiframe control message is imminent;
receive a retransmission of the multiframe control message, when a received frame of the multiframe control message has an erasure; and
reconstruct the multiframe control message from corresponding received frames of both the first transmission and the retransmission.

14. The software program of claim 13, further causing the controller to:
send a request to a mobile unit in the wireless communication system for the multiframe control message; and
expect the mobile unit to respond within a predetermined time period.

15. The software program of claim 13, wherein, in receiving a retransmission of the multiframe control message, when a received frame of the multiframe control message has an erasure, the software program further causes the controller to:
discover the erasure; and
in response to discovering the erasure, perform one of:
sending a negative acknowledgment;
sending no response; and
requesting the retransmission.

16. The software program of claim 13, further causing the controller to:
discard a frame of the retransmission that is identical to a corresponding frame of a prior transmission of the multiframe control message; and
replace an erased frame of the prior transmission with a non-erased frame of the retransmission.

17. The software program of claim 13, further causing the controller to
deactivate the buffer after reconstructing the multiframe control message.

18. The software program of claim 13, further causing the controller to
repeat receiving the retransmission of the multiframe control message and reconstructing the multiframe control message until a message error check is passed.
